(19) United States
(12) Patent Application Publication
(10) Pub. No.: US 2009/0254671 A1
(43) Pub. Date: Oct. 8, 2009

(54) Remote control of a device by a terminal

(75) Inventors: Herve Richard, Dunkerque (FR); Vincent Murphy, La Mdeleine (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/385,090

(22) Filed: Mar. 30, 2009

(30) Foreign Application Priority Data
Mar. 31, 2008 (FR) 08 52114

(51) Int. Cl. G06F 15/16

(52) U.S. Cl. 709/230

(57) ABSTRACT

A device (14) belonging to a first network is controlled from a terminal (13) able to communicate through a second network by means of a communication protocol. The device is adapted to implement at least one application able to be remotely controlled through the first network, by a control entity (15), by means of a control protocol.

A network entity connects the first and second networks. This network entity receives, from the terminal, a control message (31) conforming with the communication protocol. Then, it translates the control message conforming with the communication protocol into a translated control message (32) conforming with the control protocol adapted for controlling the application. Then, it transmits the translated control message to the control entity.

The present invention relates to the field of the management of devices located remotely, such as in a place of residence for example.

Systems are known which offer the possibility of remotely controlling and/or managing electronic devices within the same network, on the basis of the standardized equipment control protocol UPnP (Universal Plug and Play) defined by the UPnP forum.

Such systems generally include a plurality of devices which offer a service to a potential user and at least one control point intended for remotely controlling this plurality of devices.

More precisely, an architecture according to UPnP is that of a distributed platform offering dynamic services via peripherals which communicate, such as for example a printer, a television set, a DVD player, or also roller blinds. It thus makes it possible, in particular, to add personal computers and peripheral equipment to the network item by item in an automatic manner.

UPnP defines network protocols allowing the automatic detection and dynamic withdrawal of such peripheral equipments, the use by the control points of the services that they offer and the notification of the changes of variable status values associated with the devices or with the services. These protocols are, in particular, based on the XML (eXtensible Markup Langage), HTTP (Hyper Text Transfer Protocol), TCP (Transmission Control Protocol) and UDP (User Data Protocol) protocols.

In such an architecture, provision is therefore made for being able to control these networked items of equipment. Thus, for example, a personal computer can control a printer.

However, it is appropriate to state that such a networking of devices to be controlled and of one of more control entities adapted to control them depends on the UPnP protocol layer installed in all the devices and control entities being able to communicate with each other in such a network.

The present invention aims to improve the situation.

A first aspect of the present invention proposes a method of controlling at least one device belonging to a first network, from a terminal able to communicate through a second network by means of a communication protocol;

said device being adapted to implement at least one application which is able to be remotely controlled through the first network, by a control entity connected to the first network, by means of a control protocol;
said method comprising the following steps, implemented by a network entity connecting said first and second networks:
/1/ receiving, from the terminal, a control message conforming with said communication protocol, the control message not conforming with said control protocol;
/2/ translating said control message into a translated control message conforming with said control protocol and adapted for controlling said application;
/3/ transmitting the translated control message to said control entity.

The first network can correspond to a network adapted for supporting a control protocol of the UPnP type in which a plurality of devices, able to implement a plurality of applications, for possibly respectively offering services, can be controlled by one or more control entities.

A device to be remotely controlled according to an embodiment of the present invention comprises an application which can be implemented by remote control. Hereafter, by way of illustration, it will be considered that such an application corresponds to a service being offered.

The second network can correspond to any communication network whatsoever, such as in particular a mobile telecommunications network, or a WiFi network. This second network can, unlike the first network, not be a network of the UPnP type. More precisely, the second network comprises devices which are not adapted for UPnP actions, unlike the devices of the first network.

The terminal which is adapted to control a device of the first network can then advantageously correspond to a mobile terminal. In this case, a user of a mobile terminal can control the functioning of a device situated remotely in the first network without however this terminal having a protocol layer of the UPnP type. It is thus possible, for example, to envisage that a user programs the temperature of his place of residence from his mobile telephone, if his place of residence is equipped with a network of the UPnP type.

A device to be controlled in the first network can be, as defined in the UPnP architecture, of the DMS (Digital Media Server) type which is a server distributing digital content in this first UPnP network; or also of the DMR (Digital Media Renderer) type, which is a device whose task is to restore a multimedia content.

The second network can correspond to a network of any type whatsoever, in which the terminal of the second network can be a fixed or mobile terminal. It is appropriate to note that the present invention can advantageously be applied when the terminal in question in the second network is neither configured nor adapted to communicate using the control protocol that it is provided for use in the first network.

Due to these arrangements, it is possible to implement the remote control of a device which is within a network and which implements an application adapted for being controlled by means of the UPnP control protocol, without however requiring the installation of a specific application of the UPnP type on the terminal in question for the implementation of a control protocol used within the first network. In fact, due to the network entity which receives the control messages transmitted by the terminal, the latter can communicate with the device to be controlled.

This network entity allows any equipment, such as a mobile terminal, a personal computer or a television set, to remotely control a device through any second network, which can be a local network, based on the WiFi protocol, or also the Ethernet protocol or also a remote network based on the Internet protocol or a mobile communication network, without it being required for that equipment to have a specific communication module using a specific protocol.

Such a control can make it possible to simultaneously control applications relating to services on the “push model” and also services on the “pull model”, with regard to audio or video data.

At the level of the network entity, it is moreover possible to provide for the implementation of the following steps:
/i/ receiving an information message conforming with the control protocol containing information relating to the device from said device;
/ii/ translating said information message into a translated information message conforming with the communication protocol; and
/iii/ transmitting the translated information message to the terminal.

Thanks to these characteristics, it is then possible to inform the terminal on certain aspects of the device that it is able to control. Thus, it is possible to provide for transmitting the status changes of the device to the terminal. It is also possible to envisage advantageously that the terminal thus receives the initial information required to enable it to control that device. Such can be the case, in particular, when the first network is a UPnP network and the detection of a new device connected in this network is carried out dynamically. In this case, the control entity receives information on the new device connected and can thus transmit it to the network entity which itself is able to transmit it to the terminal.

The first network can be a UPnP network, the control protocol then being the UPnP protocol.

The terminal can be a mobile terminal or also a fixed terminal, of the personal computer type for example.

A second aspect of the present invention proposes a method of control of at least one device belonging to a first network, from a terminal able to communicate through a second network by means of a communication protocol;

said first and second networks being connected via a network entity;
said device implementing at least one application able to be remotely controlled through the first network, by a control entity connected to the first network, by means of a control protocol;
said method comprising the following steps at the level of said control entity:
/1/ receiving a control message conforming with said control protocol from the network entity;
/2/ transmitting a control message conforming with the control protocol adapted for controlling said at least one application on the device.

A third aspect of the present invention proposes a network entity adapted for implementing a control method according to the first aspect of the present invention.

A fourth aspect of the present invention proposes a control entity adapted for implementing a control method according to the second aspect of the present invention.

A fifth aspect of the present invention proposes a device control system comprising a network entity according to the third aspect of the present invention and a control entity according to the fourth aspect of the present invention.

A sixth aspect of the present invention proposes a computer program intended to be installed in a network entity according to the third aspect of the present invention, comprising instructions capable of implementing the method according to the first aspect of the present invention, during an execution of the program by of the processing means of the network entity.

A seventh aspect of the present invention proposes a computer program intended to be installed in a control entity according to the fourth aspect of the present invention, comprising instructions capable of implementing the method according to the second aspect of the present invention, during an execution of the program by processing means of the control entity.

Other aspects, objectives and advantages of the invention will become apparent on reading the description of one of its embodiments.

The invention will also be better understood with the help of the drawings, in which:

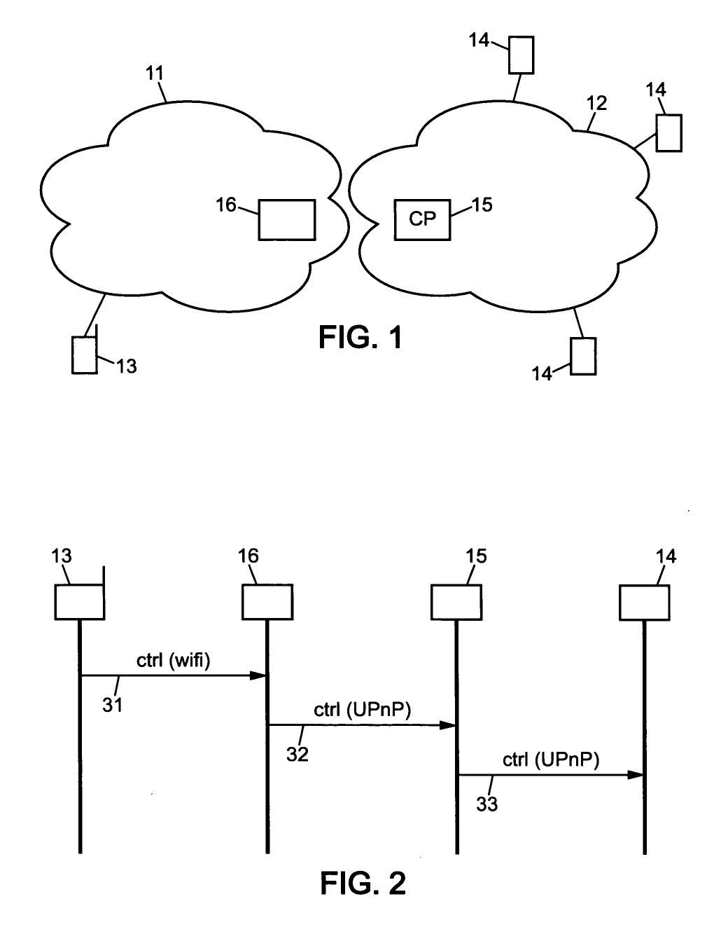

FIG. 1 illustrates an embodiment of the prior art;

FIG. 2 illustrates an exchange of messages between a terminal, a network entity connecting the first and second networks, a control entity of the first network and a device to be controlled according to an embodiment of the present invention;

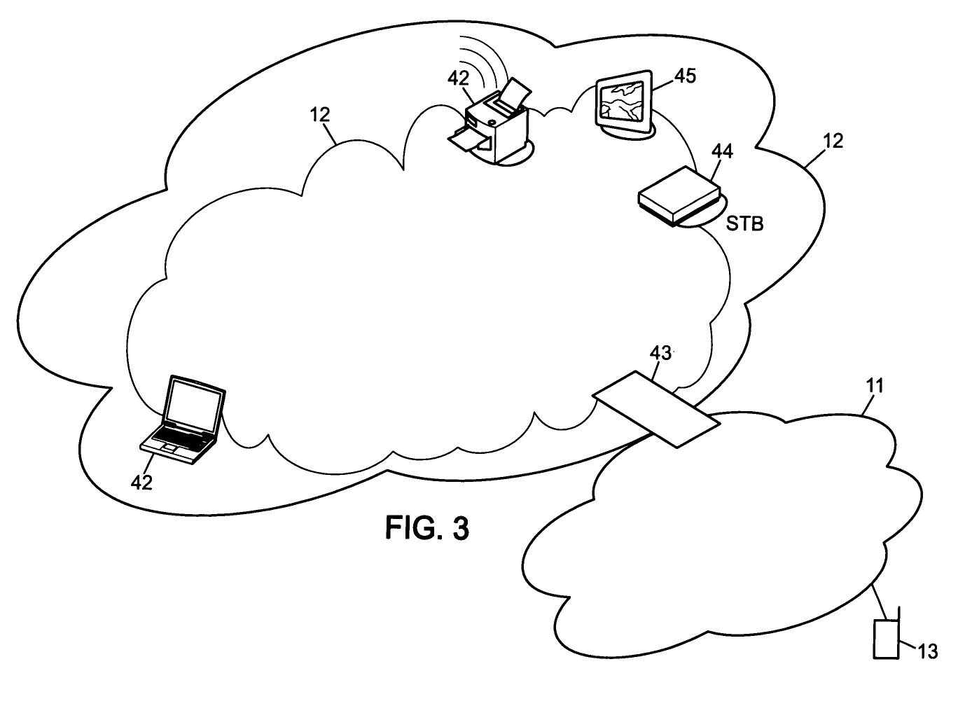

FIG. 3 illustrates an architecture according to an embodiment of the present invention;

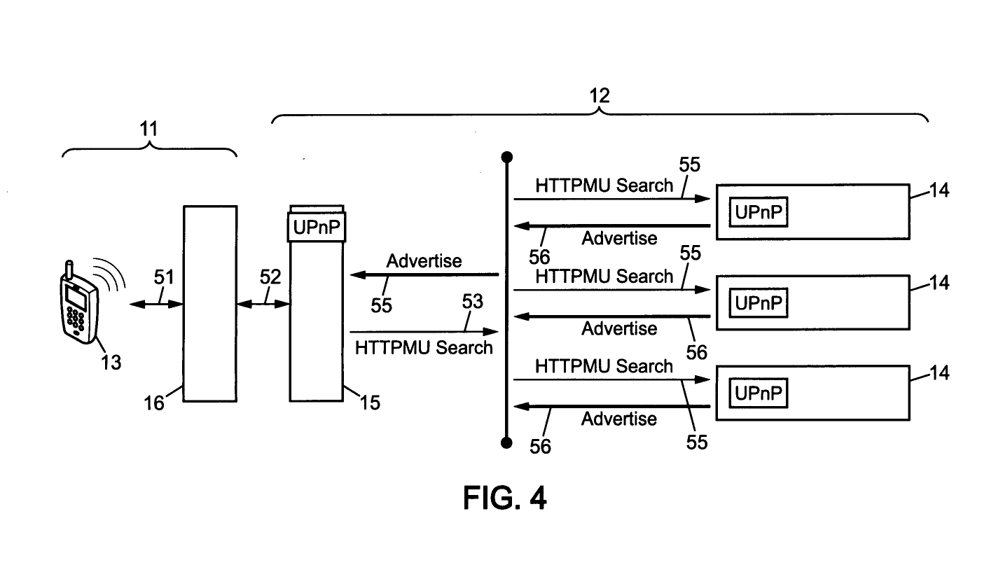

FIG. 4 illustrates an exchange of messages in an architecture according to an embodiment of the present invention;

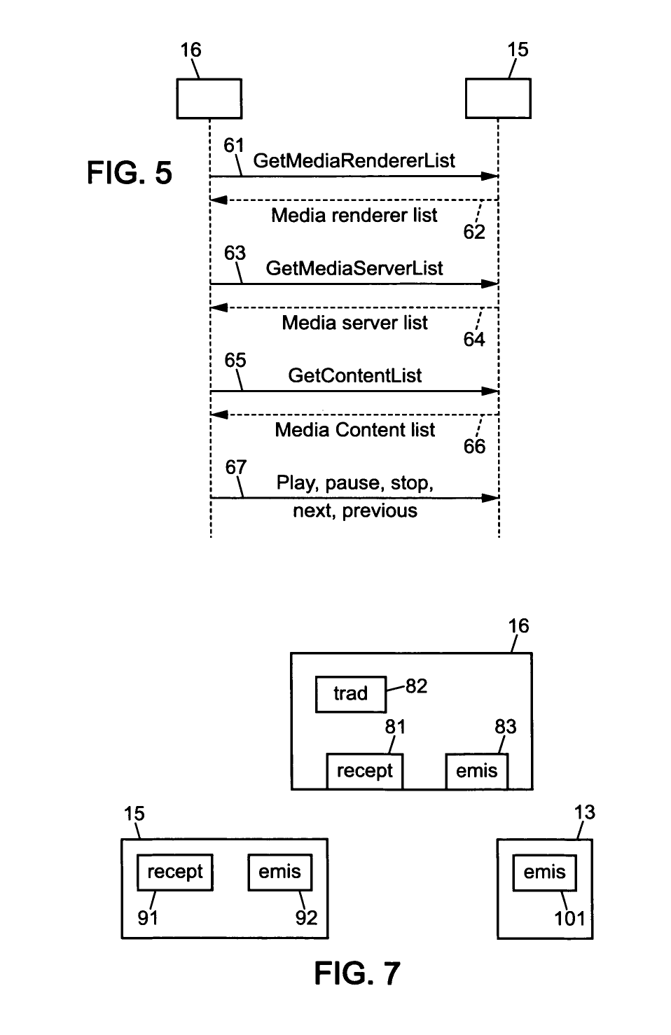

FIG. 5 illustrates exchanges of messages in an architecture according to an embodiment of the present invention;

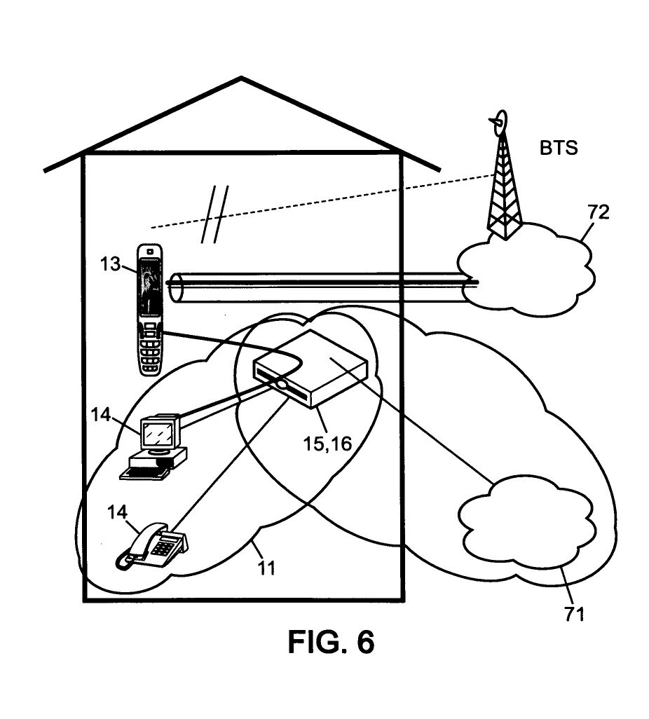

FIG. 6 illustrates an architecture according to an embodiment of the present invention; and

FIG. 7 illustrates an architecture of a network entity, of a control entity and of a terminal according to an embodiment of the present invention.

FIG. 1 illustrates a network architecture according to an embodiment of the present invention. This architecture is based on a first network 12 in which at least one device 14 being able to be controlled from a control point 15 is situated, a network entity 16 connecting the first network to a second network 11.

This first network 12 comprises a plurality of devices 14 to be controlled by the control entity 15 by means of instructions conforming with a control protocol of UPnP or equivalent type. The first network 12 can also comprise several control entities 15. Each entity can be connected to another entity in this first network either by a wired link, for example of the Ethernet type, or also by a wireless link, such as, for example, by a link of the WiFi type.

In an embodiment of the present invention, a control entity 15 uses a communication interface with the network entity 16 and a control module of the devices 14 using the UPnP protocol.

In this first network 12, the devices 14 to be controlled can be of any type such as, for example, any computer peripheral such as a printer, or also a television set or a DVD player.

A control entity 15 adapted to control a device 14 of this first network can be located physically anywhere in this first network. Thus, it is possible to provide for integrating it in one of the devices 14 or also it is possible to provide a control entity separate from the devices 14. In this latter case, the control entity can reside in a personal computer and the device or devices to be controlled are peripherals that this computer can use and therefore control.

The UPnP protocol provides a first “discovery” phase. When a device 14 is connected to the network 12 this discovery phase of the protocol allows this device to warn the control entity or entities 15 of the applications, or services, that it is able to provide. No limitation is attached to the present invention with the regard to the type of service that a device 14 can provide, or to applications to be controlled that it is able to implement. These services can in particular relate to photos, music, video, or television. This discovery phase also allows a control entity 15 which has just been connected to the network 12 to discover the devices 14 of this network automatically and transparently with respect to a user.

This phase is based on an exchange, between the control entity 15 and the device 14, of information relating to the device 14 and to the services that it offers. It can be based on the SSDP (Simple Service Discovery Protocol) protocol, which is an automatic discovery protocol allowing the devices to be identified by control entities implementing the UPnP protocol by means of a general UDP broadcast or multicast.

Then, subsequently, a description phase is used during which more detailed information on the device can be retrieved by the control entity 15. Thus, for each service offered by a device 14, an associated description includes a list of instructions or of actions to which the service in question responds, as well as a list of variables which respectively describe the different statuses that this service can assume. This phase can be based on a protocol of the XML type.

Following a discovery phase, a control phase is instigated. In this stage, a control entity is able to control a device since it knows the actions that it can demand of it, i.e. the instructions recognized by that device.

For this phase, it is possible to envisage using a protocol of the XML type, or of the SOAP (Simple Object Access Protocol) type.

According to the UPnP protocol, it is also possible of receive, at the level of the control entity 15, event notifications from the devices 14 to be controlled. These event notifications serve to notify to the control entity 15 of an update of the variables relating to a service in progress provided by a device 14. This notification phase can be based on a protocol of the XML type, such as GENA (General Event Notification Architecture).

Finally, it is also possible to use a presentation phase in such a network 12 during which a control entity 15 is able to present a page of the URL (Uniform Resource Locator) type which is provided by a device 14. By proceeding in this way, a user can control the device 14 in question, or a status of the device 14 in question, at the level of the control entity 15.

A terminal 13 belonging to the second communication network 11 is adapted to communicate in this second network according to the communication protocol on which this network is based. Moreover, in an embodiment of the present invention, the terminal 13 has information relating to a device 14 of the first network, which allows it to transmit messages adapted for the control, and the use, of the device 14 in question. Such information can advantageously be obtained dynamically in the network, for example by means of a DNS (Domain Name Server) server or also by means of an entity interrogating the devices connected to the network in order to detect the presence of an equipment control entity. For this purpose, it is possible to provide for the network entity 16 to be adapted to receive such information originating from the control entity 15 according to the UPnP protocol, and to transmit it according to the communication protocol of the second network 11 to the terminal 13. Having such information, the terminal is able to use the device 14. This information allows it not only to identify the device 14, but also to know in particular the services that the device 14 is able to provide, as well as its status. These services are for example the services of provision of audio and/or video content. In this case information on the accessible contents (names of files, descriptions of contents, etc.) will also be supplied. It is possible to provide for supplying the terminal 13 with such information dynamically in order that it may have updated information.

Moreover, it has a user interface which invites a user of this terminal 13 to control a device 14 to be controlled. The actions that can be applied to a device 14, and therefore offered to a user via the user interface of the terminal 13, depend of the type of device 14 in question. Thus, per type of device 14, it is possible to provide for this user interface to propose a menu of actions to be required on such a device 14 of the first network.

No limitation is attached to the present invention with the regard to the method used for providing the terminal 13 with said information relating to the device or devices 14 that it can control.

It is possible to provide for the terminal to retrieve this information prior to a communication in the second network. Thus, for example, the operator of the second network can offer to a user a subscription to a remote control service via this second network according to an embodiment of the present invention. At the time of subscribing, the user can declare the device or devices of the first network that he wishes to be able to control via the second network. At this stage, the information necessary for the implementation of such control can then be stored on the terminal 13.

It is also possible to provide for the user himself to configure this information on his terminal 13.

In another embodiment, the information relating to a device 14 can be received at the level of the terminal 13 via the second network as described in a section below.

It is also possible to provide for the terminal 13 to receive the information of the device or devices 14 that it can control in the first network 12 dynamically via the control entity 15 and then the network entity 16.

Different combinations of the embodiments described above can also advantageously and easily be used.

FIG. 2 shows an exchange of messages between a terminal 13 of the second network, a network entity 16 connecting the first and second networks, a control entity 15 of the first network and a device 14 to be controlled according to an embodiment of the present invention.

At this stage, the device 14 to be controlled is connected to the control entity 15 which has the required information relating to this device 14 in order to control it and to use the application or applications that it offers in the first network 12. In this embodiment, the first network comprises equipment adapted to be controlled by means of the UPnP protocol in the first network.

The second network can be a public network or a private network. It can in particular correspond to a local network using WiFi or Bluetooth links. It can also correspond to an extensive network, for example the Internet, using for example the IP protocol as the communication protocol or any other appropriate protocol for sending a message through an extensive network.

Moreover, in the case where the second network is a local wireless network, the geographic cover of this second network is likely to comprise geographic zones common with the geographic cover zone of the first network. In other words, a mobile terminal can be used for controlling an equipment of the first network either by using a local network or by using an extensive network interconnected with the first network via the network entity 16, the two options being usable at the same time when the mobile terminal is situated in the cover zone of the local network and also accesses an extensive network. It is also possible that the equipment to be controlled is itself situated in the cover zone of the second network.

The terminal 13 has information relating to the device 14 to be controlled but, in this embodiment, is not able to communicate by means of the UPnP protocol, not being equipped with a communication module using this control protocol. It transmits a control message 31 for an application of the device 14 in question, according to the communication protocol, to the network entity 16.

The latter is adapted to translate this application control message 31 of the device 14 into a control message 32 translated so that it conforms with the UPnP control protocol and to transmit the latter message to the UPnP control entity 15 of the first network.

In an embodiment of the present invention, the parameters received in the control message from the terminal, which is not UPnP, are translated into parameters of one or more UPnP actions. For this purpose it is possible to provide a translation function specific to the type of instruction processed. In an embodiment, an instruction having a specified name is translated by applying a translation function associated with this name in order to obtain a UPnP instruction having the same name and triggering one or more UPnP actions.

The control entity is then able to transmit this control message to the device 14 in question in the form of a control message 33.

In an embodiment of the present invention, a user of the terminal 13 is able to retrieve contents stored in a directory in a device 14. In this context, the device 14 is of the DMS type, the UPnP control entity 15 is of the DMC (Digital Media Controller) type or of the ‘Control Point UPnP’ type, the network entity 16 is of the DMCP (Digital Media Controller Proxy) type. The DMCP network entity 16 can be called a proxy entity because it serves as an intermediary between the terminal 13 and the DMC control entity 15. In fact, it transmits, in particular, instructions to this control device 15, these instructions depending on what is specified in the messages transmitted by the terminal 13. Thus, the DMPC network entity 16 is in some way authorized by the terminal to send the instructions which the terminal is not able to send itself. It can therefore be called a ‘proxy’ device, insofar as, by the presence of a translation module, it serves as an intermediary between the terminal and the DMC control entity 15. In particular, it transmits instructions to the control entity according to what is specified to it by request by the terminal. It is thus authorized by the terminal for sending instructions which the terminal is not able to send itself. Conversely, it serves as an intermediary for the responses or messages transmitted by the UPnP control entity to the terminal. For this purpose, the network entity makes use of the possible protocol translations or adaptations necessary for the destination entity of the messages—the terminal 13 or the DMC control entity—to receive messages formatted according to a protocol supported by the latter.

In the embodiment considered here, the terminal 13 is adapted to transmit control messages according to a protocol of the XML-RPC (eXtensible Markup Language-Remote Procedure Call) type.

The terminal 13 transmits a message to the network entity 16, according to the XML-RPC protocol, of the following type:
browseContent(mediaServerUDN, containerID).

Then, on reception of this message, the network entity 16 transmits to the control entity 15 a control message according to an appropriate message sending procedure, for example by function calls between the network entity 16 and the control entity 15, this control message being of the following type:
browseContent(mediaServerUDN, containerID).

Thus, the message obtained is a message adapted for the UPnP protocol. In fact, it corresponds here to a UPnP action, triggered using the SOAP (Simple Object Access Protocol) protocol. This protocol allows the transmission of messages between remote entities implemented in the form of objects (in the sense of object-oriented programming): it allows in fact an object to invoke methods of another object, i.e. to initiate the execution of functions or actions by this other object.

Consequently, the control entity 15 receives the above message and transmits it via a UPnP action to a device 14, using the SOAP protocol. More precisely, in an embodiment, the DMCP network entity 16 triggers a function call so that the control entity 15 invokes, using the SOAP protocol, the execution by the device 14 of one or more UPnP actions. For example, the invoked UPnP action can as follows:
Browse(containerID, “BrowseDirectChildren”, “*”, 0, 0, “ ”).

Then, the device 14 transmits to the control entity 15 a response to the preceding UPnP action, which is transmitted to the network entity 16 according to the call procedure utilised between the control entity and the network entity. The latter translates this response in order to transmit it, using the XML-RPC protocol, to the terminal 13.

In another embodiment of the present invention, it is also possible to provide for launching the playing of a content. In this case the terminal 13 can provide a Man-Machine interface, which allows its user to choose a content to executer/play on a device 14 of the DMR type. In this context, the terminal 13 sends the network entity 16 a message, using the XML-RPC protocol, of the following type:
playContent(DMR, contentURI)

The network entity 16 translates it into the form of a message compatible with the UPnP protocol. Then, the network entity 16 transmits this adapted message to the control entity 15. More precisely, this message sending is carried out in the form of a function call. Thus, the network entity translates the received message into function calls on the control entity. The latter then transmits to the device 14 a message of the following type, which corresponds to a UPnP action:
setAVTransportURI(InstanceID=0, currentURI=contentURI, CurrentURIMetadata=“ ”)

The device 14 responds to it by a message of the type:
setAVTransportURI response

The control entity can then request that the required content is played by transmitting to the device 14 a message of the type:
play(InstanceID=0, Speed=1)

Then, the device 14 responds to it by transmitting a response message according to the UPnP protocol.

Then, the control entity transmits, using the call procedure between these network and control entities, a message to the network entity of the type:
playContent response OK

Then, the network entity DMCP 16 transmits to the terminal 13 a message, using the XML-RPC protocol, of the type:
playContent Response OK

FIG. 3 illustrates an architecture according to an embodiment of the present invention. The first network 12 is a private network of the UPnP type which comprises a set top box (STB) 44, a television set 45, a printer 42, a computer 41 and a DSL (Digital Subscriber Line) interface unit 43. This interface unit 43 can correspond to a UPnP internet gateway, or also to an IGD (Internet Gateway Device’).

Such an IGD gateway can moreover be adapted to provide a NAT (Network Address Translation) network address translation service. Thanks to this service, several devices 14 of the first UPnP network can benefit from a single connection in order to access the IP network, using the same public IP address.

The control entity 15 can in this case be integrated in the computer 41 or also in the DSL unit 43.

Thus, all the other devices can be detected automatically by the control entity 15 according to the UPnP protocol and the services rendered respectively by all these devices can then be available at the level of this control entity. If, for example, the control entity is integrated in the computer 41, then the printer 42 can be connected to the latter via a WiFi link and the other devices 43 to 45 can be connected to it by a wired link, by example of the Ethernet type. No limitation is attached to the present invention with regard to the type of physical link between the computer and the devices of this first network.

Thus, a link of any type whatsoever, wired or WiFi, connects the computer 41 and the DSL unit 43. In this embodiment of the present invention, the DSL unit 43 is a WiFi access point of a WiFi network (or Internet Gateway Device).

Here, it is possible to provide for the second network to be a WiFi network. The terminal 13 is then a terminal having a WiFi interface and can therefore be connected to the DSL unit 43.

In such a network, the control entity 15 can therefore advantageously be situated at the level of the computer 41 or of the DSL unit 43, and the network entity 16 according to an embodiment of the present invention can be situated at the level of the DSL unit 43, thus receiving the control messages from the terminal 16, translating them in such a way that they conform with the UPnP protocol in order to then transmit them in the first UPnP network 12.

Thus, the user of a mobile WiFi terminal is able to control the volume of the sound of the television set 45 in such an architecture, without requiring the installation of a communication module implementing the UPnP protocol layer in the mobile terminal he is using.

Similarly, it is easily possible to envisage implementing the network entity 16 at the level of any kind of interface whatsoever between the first network and the second network. It is thus possible to provide, instead of the DSL unit, for placing the control entity 16 in a server of the second network 11.

FIG. 4 illustrates an exchange of messages in an architecture according to an embodiment of the present invention. Such an exchange of messages can be used whatever the type of network equipment at the level of which the control entity 16 is installed may be.

The control entity 15 in the first UPnP network is adapted for discovering the devices 14 to be controlled which are present in this network. For this purpose, it transmits a discovery message 53 of the HTTPMU (Hypertext Transport Protocol MUlticast) type, i.e. a multiple broadcast or multicast message, in the network 12.

In response, it receives messages of ‘advertise’ type 55 informing it with regard to the services provided respectively by the various devices 14 of the first network 12. It is appropriate to note that a device 14 that is newly connected to the network 12 can also transmit messages of the HTTPMU type in order to determine a control unit corresponding to it.

Once the control entity 15 has information on a device 14 and on the service or services that the latter provides, it is then able to control this device 14 and to receive control messages, intended for controlling that device, from the network entity 16, whatever the location of the latter may be.

In order that the terminal 13 can receive information relating to a device 14 or several devices 14, it is possible to provide for the control entity 15 and the network entity 16 to exchange such information prior to any instructions from the terminal 13.

Such an exchange of messages 52 between the network entity 16 and the UPnP control entity 15 is shown in detail in FIG. 5 according to an embodiment of the present invention.

The control entity 15 receives a ‘GetMediaRendererList’ message 61 from the control entity 16. The control entity 15 responds to this message by supplying the list of DMR type devices 14 in a ‘Media renderer list’ message 62.

The control entity 15 receives a ‘GetMediaServerList’ message 63 from the control entity 16. The control entity 15 responds to this message by providing the list of DMS type devices 14 in a ‘Media server list’ message 64.

The control entity 15 receives a ‘GetContentList’ message 65 from the control entity 16. The control entity 15 responds to this message by providing the list of digital contents which can be provided from the UPnP network 12, in a ‘Media Content list’ message 66.

Having this information, the network entity 16 can then transmit instructions 67 or control messages of the ‘Play’, ‘Pause’, ‘Stop’, ‘Next’, ‘Previous’ type.

Provision can be made in this case for the terminal to receive, from the network entity 16, such information relating to the devices 14 that it is authorized to control via an exchange of message 51.

Whatever method is used for providing the terminal 13 with the information relating to the devices to be controlled 14, at this stage the terminal is able to transmit control messages according to one embodiment. Provision can be made for the terminal 13 to transmit a control message to the network entity 16.

When the second network 11 is a GSM (Global System for Mobile communications) or UMTS (‘Universal Mobile Telecommunication System’) cellular mobile telecommunications network, for example, the network entity is then adapted to convert a control message received from the terminal 13 conforming with the GSM or UMTS protocol into a control message conforming with the UPnP protocol to be transmitted to the control entity 15. The messages transmitted by the terminal 13 in the second network 11 can correspond to the messages of an API XML (Application Programming Interface eXtensible Markup Language’) with which the terminal 13 and the network entity 16 is then provided. These control messages can then be of the ‘SetMute’ or ‘SetVolume’ type.

At this stage, only the devices 14 for which a discovery phase has been implemented can be controlled from the terminal 13.

It is possible to provide for an update of the information at the level of the network entity 16 to be carried out automatically when the control entity ‘discovers’ a new device 14 to be controlled or a new application, possibly for a new service provided by a device 14 of the first network.

In an embodiment of the present invention, the terminal 13 is a computer provided with an HTML (Hyper Text Markup Langage) browser, the network entity 16 corresponds to a WEB server provided with an API XML. Under these conditions, the messages 51 are exchanged according to the HTTP (Hyper Text Transfer Protocol) protocol and the messages 52 are exchanged according to the XML-RPC (eXtensible Markup Langage-Remote Procedure Call) protocol.

It is also possible to make provision for the terminal 13 to host an embedded client adapted to cooperate with an XML (or ‘APL XMT (XML Application Programming Interface)) programming interface situated in the network entity 15.

FIG. 6 illustrates an architecture according to an embodiment of the present invention. The terminal 13 is adapted to operate in a WiFi network, in a UMA (Unlicenced Mobile Access) network and in a mobile communication network of the GSM or UMTS type for example. In this case, the first network 11 comprises two devices 14 in the form of a computer and a fixed telephone. The control entity 15 and the network entity 16 are integrated in the same entity in this embodiment.

The terminal 13 is also adapted to communicate via the mobile communication network 72. It is also adapted to access a network of the IP type 71 via the entity 15,16 which corresponds to a network gateway between a UPnP network and an IP network, which is not a UPnP network.

In an embodiment of the present invention, provision is made to limit the control of devices 14. For this purpose, it is possible to envisage authorizing the control of a device 14 only to a limited list of users, on the basis, for example, of a digital subscriber line account (or ‘xDSL’ account) identifier. In this case, it is possible to require that the user of the terminal 13 provides his identifier before authorizing him to take control of a device 14. It is thus possible to limit the possibility of controlling the devices 14 of a network 11 corresponding to a place of habitation to the people living in that place.

It is also possible to provide for limiting the possibility of controlling a device 14 on the basis of the MAC (Media Access Control) address of the terminal itself.

This limitation of controlling the devices 14 can be based on a prior subscription of the terminal 13 with the control entity 15 via the network entity 16. This subscription can correspond to a subscription to a network of multiple broadcast or multicast group IP addresses.

FIG. 7 illustrates an architecture of a network entity, of a control entity and of a terminal according to an embodiment of the present invention.

The network entity 16 can comprise a receiving unit 81 adapted to receive a control message 31 conforming with the communication protocol from the terminal, the control message not conforming with the control protocol; as well as a translation unit 82 adapted for translating said control message conforming with the communication protocol into a translated control message 32 conforming with the control protocol adapted for controlling the application, and a transmission unit 83 adapted for transmitting the translated control message to the control entity.

The receiving unit 81 can moreover be adapted for receiving an information message conforming with the control protocol containing information relating to the device 14 from the device, the translation unit 82 can moreover be adapted for translating the information message into an information message conforming with the communication protocol; and the transmission unit 83 can moreover be adapted for transmitting the information message conforming with the communication protocol to the terminal 13.

The control entity 15 can comprise a receiving unit 91 adapted for receiving a control message 32 conforming with the control protocol from the network entity 16 and a transmission unit 92 adapted for transmitting a control message 33 conforming with the control protocol adapted for controlling the application on the device.

The terminal 13 can comprise a transmission entity 101 adapted for transmitting a control message conforming with the communication protocol to the network entity 16 for controlling the device in the first network.

1. Method of controlling at least one device (14) belonging to a first network (12), from a terminal (13) able to communicate through a second network (11) by means of a communication protocol;
said device being adapted to implement at least one application which is able to be remotely controlled through the first network, by a control entity (15) connected to the first network, by means of a control protocol;
said method comprising the following steps, implemented by a network entity (16) connecting said first and second networks:
/1/ receiving, from the terminal, a control message (31) conforming with said communication protocol, the control message not conforming with said control protocol;
/2/ translating said control message into a translated control message (32) conforming with said control protocol and adapted for controlling said application;
/3/ transmitting the translated control message to said control entity.

2. Control method according to claim 1, comprising moreover the following steps at the level of the network entity (16):
/i/ receiving an information message conforming with the control protocol containing information relating to the device (14) from said device;
/ii/ translating said information message into a translated information message conforming with the communication protocol; and
/iii/ transmitting the translated information message to the terminal (13).

3. Control method according to claim 1 or 2, in which the control protocol is the UPnP protocol.

4. Method of controlling at least one device belonging to a first network from a terminal able to communicate through a second network by means of a communication protocol;
said first and second networks being connected via a network entity;
said device implementing at least one application able to be remotely controlled through the first network, by a control entity connected with the first network, by means of a control protocol;
said method comprising the following steps at the level of said control entity:
/1/ receiving a control message conforming with said control protocol from the network entity;
/2/ transmitting a control message conforming with the control protocol adapted for controlling said at least one application on the device.

5. Network entity (16) connecting a first and a second network (12, 11);
said first network comprising a device (14) to be controlled by means of a control protocol and said second network allowing a terminal (13) to communicate by means of a communication protocol;
said device being adapted for implementing at least one application able to be remotely controlled, through the first network, by a control entity (15) connected to the first network, by means of the control protocol;
said network entity comprising:
a receiving unit (81) adapted for receiving a control message (31) from the terminal conforming with the communication protocol, the control message not conforming with said control protocol;
a translation unit (82) adapted for translating said control message conforming with the communication protocol into a translated control message (32) conforming with the control protocol adapted for controlling said at least one application;
a transmitting unit (83) adapted for transmitting the translated control message to said control entity.

6. Network entity (16) according to claim 5, in which the receiving unit (81) is moreover adapted for receiving an information message conforming with the control protocol containing information relating to the device (14) from said device, the translation unit (82) is moreover adapted for translating said information message into a translated information message conforming with the communication protocol and the transmitting unit (83) is moreover adapted for transmitting the translated information message to the terminal (13).

7. Control entity (15) of at least one device (14) belonging to a first network (12), said device being adapted for implementing at least one application able to be remotely controlled through the first network by means of a control protocol,
said control entity being adapted for communicating with a network entity (16) connecting the first network and a second network (11), said second network allowing a terminal (13) to communicate by means of a communication protocol;
said control entity comprising:
a receiving unit (91) adapted for receiving a control message (32) from the network entity (16) conforming with the control protocol; and
a transmitting unit (92) adapted for transmitting a control message (33) conforming with the control protocol adapted for controlling said at least one application on the device.

8. System for controlling at least one device (14) belonging to a first network (12), said device having to be controlled from a terminal (13) able to communicate through a second network (11) by means of a communication protocol;
said first and second networks being connected via a network entity (16) according to claim 5;
said device being adapted for implementing at least one application able to be controlled remotely through the first network, by a control entity (15) according to claim 7, by means of a control protocol.

9. Computer program intended to be installed in a network entity (16) according to claim 5, comprising instructions capable of implementing the method according to claim 1 during an execution of the program by processing means of the network entity.

10. Computer program intended to be installed in a control entity (15) according to claim 7, comprising instructions capable of implementing the method according to the claim 4 during an execution of the program by processing means of the control entity.
